(19) United States
(12) Patent Application Publication
(10) Pub. No.: US 2020/0002483 A1
(43) Pub. Date: Jan. 2, 2020

(54) CARBON-FIBER REINFORCED POLYPROPYLENE COMPOSITION

(71) Applicant: SABIC GLOBAL TECHNOLOGIES B.V., Bergen op Zoom (NL)

(72) Inventors: Reema SINHA, Bergen op Zoom (NL); Kapil INAMDAR, Bergen op Zoom (NL); Sudha TANTRY, Bergen op Zoom (NL); Shweta HEGDE, Bergen op Zoom (NL)

(73) Assignee: SABIC Global Technologies B.V., Bergen op Zoom (NL)

(21) Appl. No.: 16/480,237

(22) PCT Filed: Jan. 25, 2018
(86) PCT No.: PCT/EP2018/051896

§ 371 Date: Jul. 23, 2019

Related U.S. Application Data
(60) Provisional application No. 62/450,222, filed on Jan. 25, 2017.

(51) Int. Cl. C08J 5/04; C08J 5/06; C08K 7/04; C08K 9/08; C08L 23/12; C08L 75/04; B29C 48/04; B29C 48/08

(52) U.S. Cl. CPC C08J 5/042; C08J 5/06; C08K 7/04; C08K 9/08; C08L 23/12; C08K 2201/004; B29C 48/04; B29C 48/08; C08J 2323/12; C08J 2451/06; C08J 2375/04; C08L 75/04

(57) ABSTRACT

Various embodiments disclosed relate to a composition. The present disclosure includes a polypropylene component and a sized carbon-fiber component. An interface is formed between the polypropylene component and the sized carbon-fiber component.

This application claims the benefit of priority to U.S. Provisional Patent Application Ser. No. 62/450,222 entitled “Carbon-Fiber Reinforced Polypropylene Composition,” filed Jan. 25, 2017, the disclosure of which is incorporated herein in its entirety by reference.

### BACKGROUND

Composite materials formed from a polymer and a reinforcing fiber can be very strong materials at a relatively light weight that can be suitable for many structural applications. The performance characteristics of the composite material can be a function of many different factors. For example, the strength of the material can depend on the materials that are used to form the composite or the connections between those materials. In order to provide composite materials that are useful for a broader range of applications it is desirable to create composites with increased strength.

### SUMMARY

Composite materials formed from a polymer and a reinforcing fiber can be desirable in that external stresses applied to the composite materials can be handled by the fibers. The strength of the composite material can be limited by the extent of the strength of the interface between the polymer and the fiber. For example, if the interface is weak, meaning that there is a poor coupling or connection between the polymer and the reinforcing fiber, then the overall strength of the composite material can be compromised.

Inclusion of certain sized fibers and grafted polypropylene compatabilizers can enhance the strength of the interface between the polymer and the fiber. For example, by modifying the surface of the fiber or modification of the polymer (e.g., with a functional group that can react with a functional group of the polymer), the interface, and the composite material as a whole, can be strengthened.

In an example of the present disclosure, a polypropylene component and a sized carbon-fiber component form an interface between the polypropylene component and the sized carbon-fiber component.

In another example of the present disclosure, a composite material is formed from a composition including a polypropylene component and a sized carbon-fiber component. An interface of the composite material includes a covalent bond formed between the polypropylene component and the sized carbon-fiber component.

In a further example of the present disclosure, a method of forming a composite material includes extruding a composition including a polypropylene component and a sized carbon-fiber component.

In a further example of the present disclosure, a method of forming a composite material includes exposing a plurality carbon-fibers to a molten polypropylene component to form a first tape. A second plurality of carbon-fibers is then exposed to a molten polypropylene component to form a second tape. The first and second tapes are then stacked and consolidated.

### BRIEF DESCRIPTION OF THE FIGURES

The drawings illustrate generally, by way of example, but not by way of limitation, various embodiments discussed in the present document.

FIG. 1 shows tensile strength for composites formed from ZOLTEK-65 carbon-fiber and various maleic anhydride grafted polypropylenes, in some embodiments.

FIG. 2 shows tensile strength for composites formed from TOHO TENAX carbon-fiber and various maleic anhydride grafted polypropylenes, in some embodiments.

FIG. 3 shows tensile strength for composites formed from ZOLTEK PP2 carbon-fiber and various maleic anhydride grafted polypropylenes, in some embodiments.

FIG. 4 shows a tan delta v. temperature plot for a composite formed from ZOLTEK 65 and various maleic anhydride grafted polypropylenes accounting for 0.01 wt % of the composite, in some embodiments.

FIG. 5 shows a tan delta v. temperature plot for a composite formed from ZOLTEK 65 and various maleic anhydride grafted polypropylenes accounting for 0.02 wt % of the composite, in some embodiments.

FIG. 6 shows a tan delta v. temperature plot for a composite formed from TOHO TENAX and various maleic anhydride grafted polypropylenes accounting for 0.01 wt % of the composite, in some embodiments.

FIG. 7 shows a tan delta v. temperature plot for a composite formed from TOHO TENAX and various maleic anhydride grafted polypropylenes accounting for 0.02 wt % of the composite, in some embodiments.

FIG. 8 shows a tan delta v. temperature plot for a composite formed from ZOLTEK PP2 and various maleic anhydride grafted polypropylenes accounting for 0.01 wt % of the composite, in some embodiments.

FIG. 9 shows a tan delta v. temperature plot for a composite formed from ZOLTEK PP2 and various maleic anhydride grafted polypropylenes accounting for 0.02 wt % of the composite, in some embodiments.

FIG. 10 shows SEM micrographs of composite materials formed from ZOLTEK-65 carbon-fibers and various maleic anhydride grafted polypropylenes, in some embodiments.

FIG. 11 shows SEM micrographs of composite materials formed from TOHO TENAX carbon-fiber and various maleic anhydride grafted polypropylenes, in some embodiments.

FIG. 12 shows SEM micrographs of composite materials formed from ZOLTEX PP2 carbon-fiber and various maleic anhydride grafted polypropylenes, in some embodiments.

FIG. 13 is an FTIR graph for a connection study of SCONA with TOHO TENAX carbon-fiber, in some embodiments.

FIG. 14 is an FTIR graph for a connection study of FIG. 13 is an FTIR graph for a connection study of ADMER with TOHO TENAX carbon-fiber, in some embodiments.

FIG. 15 is an FTIR graph for a connection study of FIG. 13 is an FTIR graph for a connection study of BONDYRAM with TOHO TENAX carbon-fiber, in some embodiments.

FIG. 16 is an FTIR graph for a connection study of SCONA with ZOLTEK 65 carbon-fiber by FTIR, in some embodiments.

FIG. 17 is an FTIR graph for a connection study of SCONA with Hydrosize U2022 PU sizing by FTIR, in some embodiments.

### DETAILED DESCRIPTION

Reference will now be made in detail to certain embodiments of the disclosed subject matter, examples of which are illustrated in part in the accompanying drawings. While the disclosed subject matter will be described in conjunction with the enumerated claims, it will be understood that the exemplified subject matter is not intended to limit the claims to the disclosed subject matter.

Composite materials formed from a polymer and a reinforcing fiber can be desirable in that external stresses applied to the composite materials can be shared with the fibers. The strength of the composite material is sometimes limited by the extent of the strength of the interface between the polymer and the fiber. For example, if the interface is weak, meaning that there is a poor coupling or connection between the polymer and the reinforcing fiber, then the overall strength of the composite material can be compromised.

Inclusion of certain sized fibers and grafted polypropylene compatabilizers can enhance the strength of the interface between the polymer and the fiber. For example, by modifying the surface of the fiber or modification of the polymer (e.g., with a functional group that can react with a functional group of the polymer), the interface, and the composite material as a whole, can be strengthened.

Various embodiments are directed to a composition comprising a polypropylene component and a sized carbon-fiber component. The composition can take on many forms, including a composite material. The sizing can range from about 0.01 wt % to about 30 wt % of the carbon-fiber component, or from about 0.1 wt % to about 10 wt % of the carbon-fiber component, or from about 1 wt % to about 5 wt % of the carbon-fiber component. The sized carbon-fiber component can include many different types of sizings. For example, the sizing comprises a polyurethane or polypropylene sizing. Nucleophilic groups can be end groups or branched groups extending from the sizing that can react with the polypropylene component of the composition.

An interface can be defined in the composition between the polypropylene component and the sized carbon-fiber component. For example, the interface can be formed from a connection between the polypropylene component and the sized carbon-fiber. The connection can be one of many types of connections such as a chemical bond (e.g., covalent, ionic, or hydrogen bond), a physical connection (e.g., van der Waals forces or a mechanical connection), or a combination thereof.

The composition of the embodiments can have any suitable amount of the sized carbon-fiber component and of the polypropylene component. The amounts of each component can vary depending on the specific application or desired properties of the composition. For example, the sized carbon-fiber component can range from about 1 wt % to about 80 wt % of the composition, or about 15 wt % to about 60 wt % of the composition, or about 30 wt % to about 50 wt % of the composition. The polypropylene component can range from about 1 wt % to about 70 wt % of the composition, or about 15 wt % to about 60 wt % of the composition, or about 30 wt % to about 50 wt % of the composition.

In some embodiments, the sized carbon-fiber component and the polypropylene component are in direct contact at the interface. In some examples, the interface can be formed by covalent bonds that are formed between the polypropylene component and the sized carbon-fiber component. For example, the covalent bond can be formed between the surface of the sized carbon-fiber component and an electrophilic side chain grafted to the polypropylene component. Examples of suitable electrophilic side chains of the polypropylene component are provided herein. The degree to which the electrophilic side chains of the polypropylene component and the surface of the sized carbon-fiber component are bonded to each other can range from about 0.05 mol % to about 100 mol % or about 50 mol % to about 100 mol % or about 0.05 mol % to about 5 mol %. The electrophilic side chain can be covalently bonded to the surface of the sized carbon-fiber component.

A higher percentage of the electrophilic side chains covalently bonded to the surface of the sized carbon-fiber component can have the effect of strengthening the interface.

The interface between the polypropylene component and the sized carbon-fiber can also be formed through various non-covalent physical connections as opposed to, or in combination with, the covalent bonding described above. For example, the polypropylene component and the sized carbon-fiber can be joined though an ionic bond. Additionally, hydrogen bonds can be formed between the polypropylene component and the sized carbon-fiber component. For example, the hydrogen bond can be formed between electrophilic side chains of the polypropylene component and the nucleophilic group of the sized carbon-fiber component.

In some examples, physical interactions can connect the sized carbon-fiber component and polypropylene component. For example, van der Waals forces between electrophilic side chains of the polypropylene component and the surface of the sized carbon-fiber component can exist, which form the interface between them. In some examples, the interface can be formed from a mechanical connection between the polypropylene component and the sized carbon-fiber component. For example, the polypropylene component can be wrapped around the sized carbon-fiber component. The polypropylene component can be fully wrapped around the sized carbon-fiber or partially wrapped around the sized carbon-fiber. The mechanical connection between the polypropylene component and the sized carbon-fiber component can be enhanced by modifying the surface of the sized carbon-fiber component. For example, the surface roughness of the sized carbon-fiber component can be increased. As the surface roughness increases, the connection between the polypropylene component and the sized carbon-fiber component can increase.

The connection at the interface of the polypropylene component and the sized carbon-fiber can also be a combination of any of the above described connections. That is, the interface can include covalent bonds, ionic bonds, van der Waals forces, hydrogen bonds, a mechanical connection, a co-crystallization, or any combination thereof.

In some examples the composition can include a second polypropylene component. Similar to the first polypropylene component, the second polypropylene component can include a variable amount of repeating units comprising an electrophilic side chain. In some examples, the second polypropylene component can be free of the electrophilic side chain. The second polypropylene component can, in some examples, be a polypropylene homopolymer or copolymer. An example of a polypropylene copolymer can be a copolymer formed from propylene and ethylene monomers arranged in a block or random configuration.

The second polypropylene component can join to the sized carbon-fiber in a manner similar to that of the previously described polypropylene component. Additionally, an interface can be formed between the second polypropylene component and the first polypropylene component. In one example, the sized carbon-fiber can be pre-coated with the first polypropylene component. The second polypropylene component can then be attached to form an interface between the polypropylene component and the second polypropylene component. In other examples, the sized carbon-fiber can be pre-coated with the second polypropylene component. The first polypropylene component can then be attached to form an interface between the polypropylene component and the second polypropylene component. The interface can comprise covalent bonds, ionic bonds, van der Waals forces, hydrogen bonds, a mechanical connection or any combination thereof.

The strength of the composite material can be assessed in many different ways. As described in the examples herein, the integrity of the interface between the polypropylene component and the sized carbon-fiber can be one way to assess the strength. The integrity can be assessed through SEM, tensile strength testing, or DMTA-TAN testing. In a SEM test, for example, the spacing between the fiber and polypropylene component can relate to the integrity of the interface. That is, the absence of a gap between the polypropylene component and the sized carbon-fiber suggests a stronger connection and overall stronger material. Additionally the presence of fibrils between the matrix and the sized carbon-fiber can be a sign of good adhesion and integrity. The length of the sized carbon-fibers can also impact the strength of the composite material. In some examples the material has a tensile strength at break ranging from about 5 MPa to about 2000 MPa, or about 50 MPa to about 1500 MPa, or about 300 MPa to about 1000, or about 500 MPa to about 700 MPa.

Sized carbon-fibers or carbon fibres (alternatively CF, graphite fiber or graphite fibre) can be fibers of any suitable length, diameter, and aspect ratio. The sized carbon-fiber can be an “endless” carbon-fiber having virtually any length. In other examples, the sized carbon-fiber can have a length ranging from about 5 microns to about 5000 meters, from about 1 millimeter to about 3000 meters, from about 3 millimeters to about 100 meters, from about 5 millimeters to about 120 millimeters or from about 5 millimeters to about 50 millimeters. The atomic structure of sized carbon-fiber is typically similar to that of graphite, which includes sheets of carbon atoms arranged in a regular hexagonal pattern (graphene sheets), the difference between the two being the way these sheets interlock.

Depending upon the precursor used to make the fiber, sized carbon-fiber can be turbostratic or graphitic, or have a hybrid structure with both graphitic and turbostratic parts present. In turbostratic sized carbon-fiber, the sheets of carbon atoms are folded, or “crumpled,” together. For example, sized carbon-fibers derived from polyacrylonitrile (PAN) are turbostratic, whereas sized carbon-fibers derived from mesophase pitch are graphitic after heat treatment at temperatures exceeding 2200° C. Turbostratic sized carbon-fibers tend to have high tensile strength, whereas heat-treated mesophase-pitch-derived sized carbon-fibers have high Young's modulus (e.g., high stiffness or resistance to extension under load) and high thermal conductivity.

Regardless of the form of the sized carbon-fiber (e.g., turbostratic vs. graphitic), the sized carbon-fiber component of the various compositions described herein can be modified to comprise a sizing. In some embodiments, the sizing can be formed from polyurethanes or polypropylenes. The sizing can include a nucleophilic group, such that the surface of the sized carbon-fiber component comprises at least one, but generally a plurality, of nucleophilic groups that can interact with the polypropylene component to form an interface. The nucleophilic group can be selected from the group of a hydroxy group, a carboxyl group, an amine group, and a combination thereof. In various examples, the amine group can be a primary amine group. In various examples, the sized surface comprises about 0.05 mol % to about 20 mol % nucleophilic groups, or about 0.05 mol % to about 10 mol % nucleophilic group.

The sized carbon-fiber component of the composition can comprise one or more sized carbon-fibers. The sized carbon-fiber component can comprise multiple sized carbon-fibers that include the same nucleophilic group(s) accounting for the same mol %. In some examples, the sized carbon-fiber component can include a mixture of sized carbon-fibers having different nucleophilic groups forming different sized surfaces. In some examples, the nucleophilic groups on different sized carbon-fibers can be the same, but the mol % of the nucleophilic groups can differ. Additionally, some sized carbon-fibers can include nucleophilic groups, while others are free of nucleophilic groups but have other features to help form the interface (e.g., a roughed surface).

The polypropylene component of the composition is a polypropylene copolymer. Suitable polypropylenes include a polypropylene available under the trade designation, ADMER AT2305A, available from Mitsui Chemicals; a polypropylene available under the trade designation SCONA TPPP 9212 FA, available from BYK Additives & Instruments; a polypropylene available under the trade designation, BONDYRAM 1001 available from Polyram; and a polypropylene available under the trade designation, FUSABOND P613, available from DuPont. The polypropylene copolymer comprises a repeating unit including a grafted electrophilic side chain. Each repeating unit can be independently in a random, block, or alternating configuration. In some specific examples of the polypropylene component, the repeating units are in random configuration. The polypropylene component can also include polypropylenes that do not include grafted electrophilic side chains.

In various embodiments, the polypropylene copolymer includes the grafted electrophilic side chains along the backbone of the copolymer. In some embodiments, the grafted electrophilic side chains can react with the surface of the sized carbon-fiber. The electrophilic side chain can include electrophilic moieties capable of reacting with, e.g., nucleophilic groups comprised on the surface of the sized carbon-fiber component. Suitable electrophilic moieties present on the electrophilic side chains include, but are not limited to, carbonyl groups, cyano groups, isocyanate groups, haloalkyls, epoxides, and alkenyls. Suitable carbonyl groups comprise an ester, a carboxylic acid, an anhydride, an amide, and combinations thereof.

The polypropylene copolymer can have the structure in Formula I:

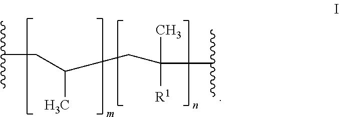

R¹ can be the grafted electrophilic side chain. In various embodiments, R¹ can be chosen from: —(C₂-C₂₀)alkoxyl, —(C₂-C₂₀)acyl,

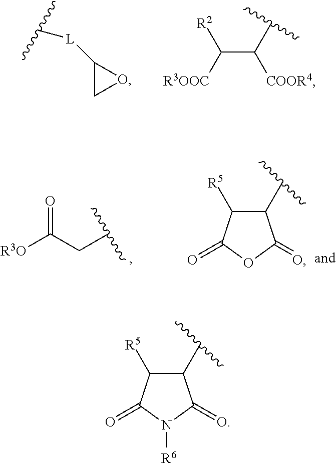

L, can be chosen from a bond, —(C₂-C₂₀)alkyl, —(C₂-C₂₀)alkoxyl, —(C₂-C₂₀)alkenyl, and —(C₂-C₂₀)cycloalkyl. R², R³, R⁴, and R⁵ can be independently chosen from —H, —(C₂-C₂₀)alkyl, —(C₂-C₂₀)alkoxyl, —(C₂-C₂₀)alkenyl, —(C₂-C₂₀)cycloalkyl, —(C₂-C₂₀)acyl, —(C₂-C₂₀)aryl, —C₁, and —Br. R⁶ can be chosen from —H, —(C₂-C₂₀)alkyl, —(C₂-C₂₀)alkoxyl, —(C₂-C₂₀)alkenyl, —(C₂-C₂₀)cycloalkyl, —(C₂-C₂₀)acyl, and —(C₂-C₂₀)aryl. In Formula I, m and n represent the mole fractions of each monomer and m can be from about 0.5 to about 0.95 and n can be from about 0.05 to about 0.5. In some embodiments, n can range from about 0.1 to about 0.4, or from about 0.1 to about 0.3, or from about 0.1 to about 0.2. In some examples R¹ can be:

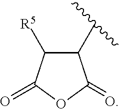

In some examples R¹ can be:

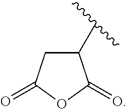 [SMILES: *C1CC(=O)OC1=O]

Because there are many different types of polypropylene units and electrophilic-side-group containing units that can be used, there can be great variety in the polypropylene component that can be formed. One such example includes a polypropylene copolymer having a repeating unit grafted with a maleic anhydride (PP-g-MA). Similarly, there can be great variability in the sized carbon-fibers that can be used. One such example includes polyurethane sized carbon-fibers, which include a primary amine group. The grafted maleic anhydride and the primary amine group can react with each other to form a bond between them. These materials appear to be stronger (e.g., higher tensile strength) than materials formed from those that do not include a primary amine group on the sized surface. The inventors have further found that polypropylene components with a higher percentage of grafted maleic anhydride form stronger materials with carbon-fibers including primary amine groups than materials formed from polypropylene components with a comparatively lower percentage of grafted maleic anhydride when both are added to contain the same weight % of maleic anhydride in the overall formulation.

The electrophilic-side-group-containing repeating unit can be less than 50 mol % of the polypropylene copolymer. For example, the electrophilic side group containing repeating unit can range from about 0.2 mol % to about 50 mol % of the polypropylene copolymer, or about 0.2 mol % to about 20 mol % of the polypropylene copolymer, or about 0.2 mol % to about 9 mol % of the polypropylene copolymer. In some examples, the electrophilic side group repeating units can only be present as end groups on the polypropylene copolymer. Of those electrophilic-side-group-containing repeating units, about 0.05 mol % to about 100 mol %, or about 0.2 mol % to about 100 mol %, or about 1 mol % to about 100 mol %, or about 10 mol % to about 100 mol %, or about 30 mol % to about 100 mol %, or about 50 mol % to about 100 mol %, or about 70 mol % to about 100 mol % of the R¹ groups can be covalently bonded to the nucleophilic group (e.g., amine group) of the sized carbon-fiber component.

The composite material can be formed by combining the sized carbon-fiber or an unsized carbon-fiber sized with the first or second polypropylene components into a machine such as a single or twin screw extruder, to produce pellets having a desired aspect ratio defined by a length and width/diameter of the pellet. The extruded pellets can then be formed into a part through any suitable process known in the art such as injection molding or compression molding. The material temperature at which the part can be formed in these examples can vary, and generally would be above the Tₘ of the polypropylene component. A suitable temperature range for the tool and the fiber reinforced polymeric material for part processing can be from about 25° C. to about 250° C., or about 35° C. to about 225° C. Parts can be formed through a one-step injection molding or through an over molding process.

Alternately, a part can be formed through a lamination process in which a spool of continuous fibers as described above are pulled under tension and exposed to molten first polypropylene component and optionally to molten second polypropylene component polymer. The continuous fibers are exposed to the molten polypropylene, for example, by immersion, to achieve partial or full impregnation of the fibers by the polymer. Other and additional processes might be used to produce such continuous fiber reinforced tapes or prepregs, as is known to those familiar with the art. This forms a tape in which the continuous fibers are substantially parallel to each other. Additional tapes can be formed similarly and stacked with respect to each other. Adjacent layers of tape can be stacked such that the continuous fibers in adjacent layers are parallel or offset with respect to each other. After a desired amount of tape layers are stacked to form an assembly, layers are consolidated under suitable conditions of pressure, temperature, and duration of time to from a laminate. Tapes can additionally be woven into pattern to form a mat. Multiple mats can be stacked on top of one another and laminated to form a product.

In another example of the lamination process, the continuous unidirectional fibers can be replaced by fabrics with more than a single orientation of the fibers within a given layer which can be discontinuous or continuous in form. Multiple layers of these fibers can then be consolidated by stacking on each other with desired fiber orientation for each layer.

### Additional Embodiments

The following exemplary embodiments are provided, the numbering of which is not to be construed as designating levels of importance:

Embodiment 1 provides A composite comprising:

a carbon-fiber component comprising a sizing; and

a polypropylene component,

wherein:

the carbon-fiber component and the polypropylene component define an interface therebetween; and

the sizing comprises polyurethane resin at least partially coating the carbon-fiber component, and at least one repeating unit of the polyurethane resin comprises at least one nucleophilic side chain interacted with the polypropylene component.

Embodiment 2 provides the composite of Embodiment 1, wherein the carbon-fiber component is about 1 wt % to about 80 wt % of the composition.

Embodiment 3 provides the composite of any one of Embodiments 1 or 2, wherein the carbon-fiber component is about 15 wt % to about 60 wt % of the composition.

Embodiment 4 provides the composite of any one of Embodiments 1-3, wherein the carbon-fiber component is about 35 wt % to about 45 wt % of the composition.

Embodiment 5 provides the composite of any one of Embodiments 1-4, wherein the sizing is about 0.01 wt % to about 30 wt % of the carbon-fiber component.

Embodiment 6 provides the composite of any one of Embodiments 1-5, wherein the sizing is about 0.01 wt % to about 10 wt % of the carbon-fiber component.

Embodiment 7 provides the composite of any one of Embodiments 1-6, wherein the sizing is about 0.01 wt % to about 5 wt % of the carbon-fiber component.

Embodiment 8 provides the composite of any one of Embodiments 1-7, wherein the sizing comprises about 0.05 mol % to about 20 mol % nucleophilic side chains.

Embodiment 9 provides the composite of any one of Embodiments 1-8, wherein the sizing comprises about 0.05 mol % to about 10 mol % nucleophilic side chains.

Embodiment 10 provides the composite of any one of Embodiments 1-9, wherein at least one of the nucleophilic side chains is chosen from at least one of a hydroxyl group, a carboxyl group, and an amine group.

Embodiment 11 provides the composite of any one of Embodiments 1-10, wherein at least one of the nucleophilic side chains is an amine group.

Embodiment 12 provides the composite of Embodiment 11, wherein the amine group is a primary amine group.

Embodiment 13 provides the composite of any one of Embodiments 1-12, wherein the carbon-fiber component has a length ranging from about 5 microns to about 5000 meters.

Embodiment 14 provides the composite of any one of Embodiments 1-13, wherein the carbon-fiber component has a length ranging from about 3 millimeters to about 100 meters.

Embodiment 15 provides the composite of any one of Embodiments 1-14, wherein the carbon-fiber component has a length ranging from about 5 millimeters to about 50 millimeters.

Embodiment 16 provides the composite of any one of Embodiments 1-15, wherein the carbon-fiber component comprises one or more carbon-fibers.

Embodiment 17 provides the composite of any one of Embodiments 1-16, wherein the polypropylene component is about 1 wt % to about 70 wt % of the composition.

Embodiment 18 provides the composite of any one of Embodiments 1-17, wherein the polypropylene component is about 15 wt % to about 60 wt % of the composition.

Embodiment 19 provides the composite of any one of Embodiments 1-18, wherein the polypropylene component is about 30 wt % to about 50 wt % of the composition.

Embodiment 20 provides the composite of any one of Embodiments 1-19, wherein the polypropylene component comprises one or more polypropylene resins.

Embodiment 21 provides the composite of Embodiment 20, wherein at least one of the resins of the polypropylene component comprises the structure in Formula I:

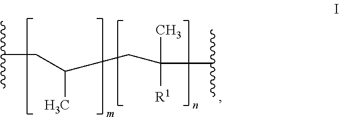

wherein R¹ is chosen from: —(C₂-C₂₀)alkoxyl, —(C₂-C₂₀)acyl,

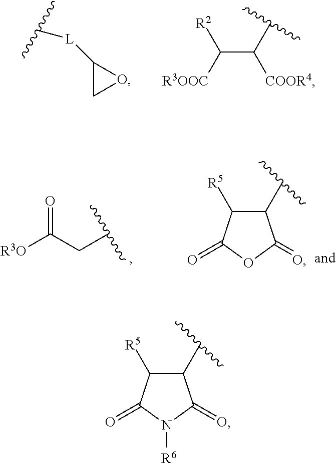

wherein L, is chosen from, a bond, —(C₂-C₂₀)alkyl, —(C₂-C₂₀)alkoxyl, —(C₂-C₂₀)alkenyl, and —(C₂-C₂₀)cycloalkyl,

wherein R², R³, R⁴, and R⁵ are independently chosen from —H, —(C₂-C₂₀)alkyl, —(C₂-C₂₀)alkoxyl, —(C₂-C₂₀)alkenyl, —(C₂-C₂₀)cycloalkyl, —(C₂-C₂₀)acyl, —(C₂-C₂₀)aryl, —Cl, and —Br,

wherein R⁶ is chosen from —H, —(C₂-C₂₀)alkyl, —(C₂-C₂₀)alkoxyl, —(C₂-C₂₀)alkenyl, —(C₂-C₂₀)cycloalkyl, —(C₂-C₂₀)acyl, and —(C₂-C₂₀)aryl,

wherein m and n represent the mole fractions of each monomer and m is from about 0.5 to about 0.95 and n is from about 0.05 to about 0.5.

Embodiment 22 provides the composite of Embodiment 21, wherein R¹ is:

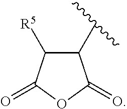

Embodiment 23 provides the composite of Embodiment 21, wherein R¹ is:

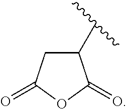 [SMILES: *C1CC(=O)OC1=O]

Embodiment 24 provides the composite of Embodiment 21, wherein n is about 0.1 to about 0.4 of the polypropylene component.

Embodiment 25 provides the composite of Embodiment 21, wherein n is about 0.1 to about 0.3 of the polypropylene component.

Embodiment 26 provides the composite of Embodiment 21, wherein n is about 0.1 to about 0.2 of the polypropylene component.

Embodiment 27 provides the composite of any one of Embodiments 1-26, wherein the carbon-fiber component and the polypropylene component are in direct contact at the interface.

Embodiment 28 provides the composite of any one of Embodiments 20-27, wherein at least one of the resins of the polypropylene component comprises at least one of a polypropylene homopolymer or copolymer.

Embodiment 29 provides the composite of any one of Embodiments 1-28, wherein the interface comprises a covalent bond formed between the polypropylene component and the sizing of the carbon-fiber component.

Embodiment 30 provides the composite of any one of Embodiments 21-29, wherein a covalent bond is formed between at least one nucleophilic side chain of the carbon-fiber component and at least one R¹ group of the polypropylene component.

Embodiment 31 provides the composite of any one of Embodiments 21-30, wherein about 0.05 mol % to about 100 mol % of the R¹ groups are covalently bonded to the sizing of the carbon-fiber component.

Embodiment 32 provides the composite of any one of Embodiments 21-31, wherein about 0.05 mol % to about 5 mol % of the R¹ groups are covalently bonded to the sizing of the carbon-fiber component.

Embodiment 33 provides the composite of any one of Embodiments 21-32, wherein about 0.05 mol % to about 100 mol % of the R¹ groups are covalently bonded to the amine group of the carbon-fiber component.

Embodiment 34 provides the composite of any one of Embodiments 21-33, wherein about 75 mol % to about 100 mol % of the R¹ groups are covalently bonded to the amine group of the carbon-fiber component.

Embodiment 35 provides the composite of any one of Embodiments 1-34, wherein the interface comprises a mechanical connection between the polypropylene component and the carbon-fiber component.

Embodiment 36 provides the composite of Embodiment 35, wherein the polypropylene component is at least partially wrapped around the carbon-fiber component.

Embodiment 37 provides the composite material of Embodiment 37, wherein a tensile strength of the composite material ranges from about 5 MPa to about 2000 MPa.

Embodiment 38 provides the composite of Embodiment 37, wherein a tensile strength of the composite material ranges from about 5 MPa to about 220 MPa.

Embodiment 39 provides the composite of any one of Embodiments 37 or 38, wherein a tensile strength of the composite comprising a bond between the polypropylene component and the amine group of the carbon-fiber component is greater than a tensile strength of a corresponding composite material that is free of a bond between the polypropylene component and the amine group of the carbon-fiber.

Embodiment 40 provides a method of forming a composite, comprising extruding a composition comprising carbon-fiber component having a sizing; and

a polypropylene component, wherein the carbon-fiber component and the polypropylene component define an interface therebetween; and the sizing comprises a polyurethane resin at least partially coating the carbon-fiber component, and at least one repeating unit of the polyurethane resin comprises at least one nucleophilic side chain interacted with the polypropylene component.

Embodiment 41 provides the method of forming the composite of Embodiments 41, wherein the composition is extruded to form a pellet.

Embodiment 42 provides the method of forming the composite material of Embodiment 41, further comprising forming a part.

Embodiment 43 provides a method of forming the composite material of Embodiment 42, wherein the part is formed through at least one of injection molding or compression molding.

Embodiment 44 provides a method of forming the composite material of claim 37, comprising:

exposing a plurality carbon-fibers having a sizing to a molten polypropylene component to form a first tape;

exposing a second plurality of carbon-fibers having a sizing to a molten polypropylene component to form a second tape;

stacking the first and second tapes; and

consolidating the first and second tapes.

Embodiment 45 provides the method of Embodiment 44, wherein the first plurality of carbon-fibers and the second plurality of carbon-fibers are substantially parallel with respect to each other.

Embodiment 46 provides the method of Embodiment 45, wherein the first plurality of carbon-fibers and the second plurality of carbon-fibers are offset with respect to each other.

### Examples

### Materials

Materials used to prepare each Example are indicated in Table 1. Each Example is a composition including a sized carbon-fiber that is coated with a polyurethane or polypropylene component. The composition further includes a polypropylene component that is a compatibilizer in that it is grafted with maleic anhydride groups. These are referred to as maleic anhydride modified polypropylenes or MA-g-PPs.

TABLE 1
Materials

| | |
|---|---|
| Zoltek - 65 | polyurethane sized carbon- |
| | fiber, available from Zoltek. |
| TOHO Tenax HT C483 (TOHO | polyurethane sized carbon- |
| TENAX) | fiber, available from Toho |
| Zoltek - PP2 | polypropylene sized carbon- |
| | fiber, available from Zoltek. |
| ADMER AT 2305A (ADMER) | a maleic anhydride (MA) |
| | modified polypropylene (PP) |
| SCONA (SCONA) TPPP9212 | a maleic anhydride (MA) |
| | modified polypropylene (PP) |
| BONDYRAM 1001 | a maleic anhydride (MA) |
| (BONDYRAM) | modified polypropylene (PP) |
| FUSABOND (FUSABOND) | a maleic anhydride (MA) |
| P613 | modified polypropylene (PP) |
| PP-Braskem F1000HC | a polypropylene homopolymer |
| Homopolymer | |
| Irganox B 225 | a blend of 50% tris(2,4-ditert- |
| | butylphenyl)phosphite and 50% |
| | pentaerythritol tetrakis[3- |
| | [3,5-di-tert-butyl-4- |
| | hydroxyphenyl]propionate]. |
| PP | Polypropylene |
| PU | Polyurethane |
| MA | Maleic Anhydride |

Carbon-fibers used in the Examples were sized with either polypropylene or polyurethane. The sizing type and sizing percentage for each carbon-fiber are listed in Table 2.

TABLE 2
Carbon-fiber Grades

| | | TOHO TENAX | |
|---|---|---|---|
| | ZOLTEK- 65 | HT C483 | ZOLTEK-PP2 |
| Sizing type | PU | PU | PP |
| Sizing % | 2.75 | 2.7 | 2.8 |

Various polypropylenes modified with maleic anhydride side chains were used. Properties of the polypropylenes along with a wt % of the maleic anhydride loading for each polypropylene are listed in Table 3.

TABLE 3
Maleic anhydride grafted polypropylene (PP-g-MA) grades.

| | | SCONA | BONDYRAM | |
|---|---|---|---|---|
| Property | ADMER | TPPP 9212 | 1001 | FUSABOND |
| Manufacturer | Mitsui | BYK | POLYRAM | DUPONT |
| | Chemicals | | | |
| Physical Form | Powder | Pellets | Pellets | Pellets |
| MFR (g/10 min) | >1000 @ | 140 @ | 100 @ | 120 @ |
| | 230 C./2.16 Kg | 190 C./2.16 Kg | 190 C./2.16 Kg | 190 C./2.16 Kg |
| Density (g/cc) | 0.91 | 0.91 | 0.91 | 0.903 |
| Melting Point (° C.) | 158 | ~160 | 160 | 162 |
| MA Loading (wt %) | ~1.5% | 1.8% | 1.0% | 0.5% |

For each Example, the MA content was selected to be either 0.01 wt % or 0.02 wt % of the total material. The total weight percent of the additive including the MA to achieve this loading was calculated and is presented in Table 4.

TABLE 4
Amount of PP-g-MA in the formulation
with PP resin and carbon-fiber.

| Desired MA | | FUSABOND | ADMER | SCONA |
|---|---|---|---|---|
| Content | BONDYRAM | additive | additive | additive |
| (wt %) | (wt %) | (wt %) | (wt %) | (wt %) |
| 0.01 | 1 | 2 | 0.67 | 0.56 |
| 0.02 | 2 | 4 | 1.33 | 1.11 |

The compounding operations were carried out in a 25 mm screw diameter on a 10-barrel with a L/D ratio of 40, W&P ZSK2 Twin Screw Extruder to prepare formulations in Table 5. Each sample was prepared by compounding the polypropylene, heat stabilizer, and polypropylene grafted maleic anhydride and sized carbon-fiber. The processing temperature was in the range of 230-240 degree C. The molding operations were carried out on LT Demag ASWA injection molding machine. The molding was done at 230 degree C. with an injection speed of 20-40 mm/min, and an injection pressure of 60-70 bar. The mold temperature was kept at 60 deg C.

TABLE 5
Formulation with all ingredients in weight percentage

| | | 0.01 wt % | 0.02 wt % | 0.01 wt % | | | | | |
|---|---|---|---|---|---|---|---|---|---|
| | | MA | MA | MA | 0.02 MA | 0.01 MA wt % | 0.02 MA wt % | 0.01 MA wt % | 0.02 MA wt |
| | Control | Admer | Admer | Scona | wt % Scona | Bondyram | Bondyram | Fusabond | % Fusabond |
| PP-Braskem F1000HC | 59.25 | 58.58 | 57.92 | 58.7 | 58.14 | 58.25 | 57.25 | 57.25 | 55.25 |
| Homopolymer | | | | | | | | | |
| Heat Stabilizer | 0.75 | 0.75 | 0.75 | 0.75 | 0.75 | 0.75 | 0.75 | 0.75 | 0.75 |
| (Irganox B 225) | | | | | | | | | |
| Zoltek-65/Toho Tenax | 40 | 40 | 40 | 40 | 40 | 40 | 40 | 40 | 40 |
| HTC483/Zoltek PP2 | | | | | | | | | |
| Admer AT2305A | | 0.67 | 1.33 | | | | | | |
| BYK SCONA TPPP9212 | | | | 0.56 | 1.11 | | | | |
| Bondyram 1001 | | | | | | 1 | 2 | | |
| Fusabond P613 | | | | | | | | 2 | 4 |
| Total | 100 | 100 | 100 | 100 | 100 | 100 | 100 | 100 | 100 |

The compounded and injection molded compositions of Table 5 were tested for various mechanical properties including tensile strength. The degree of fiber-polymer bonding was further investigated using SEM microscopy.

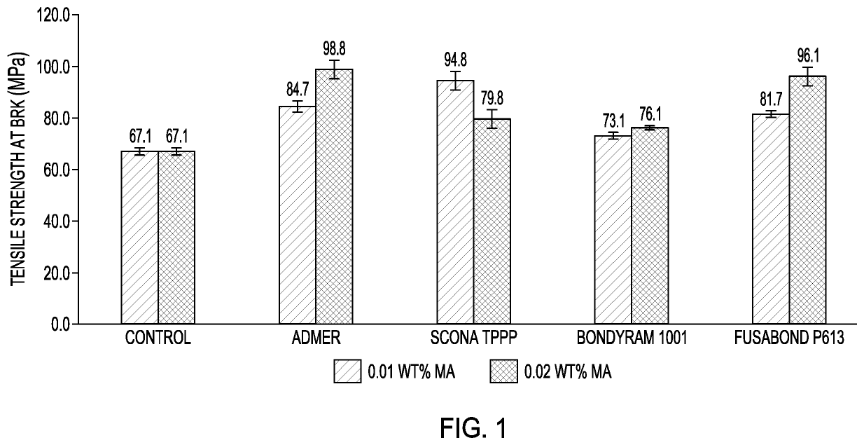

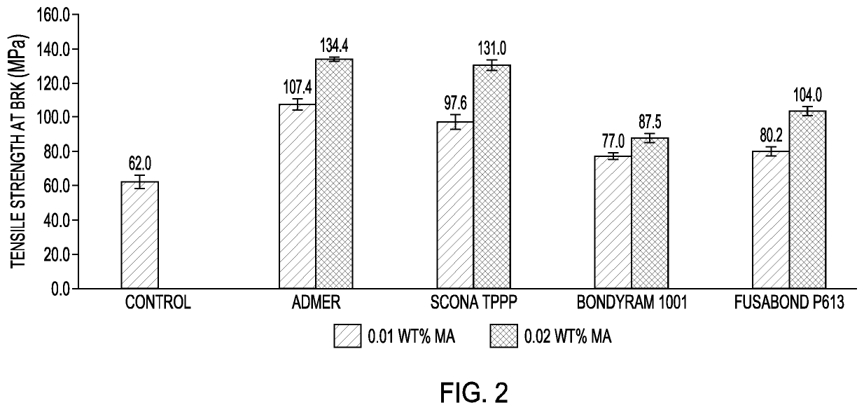

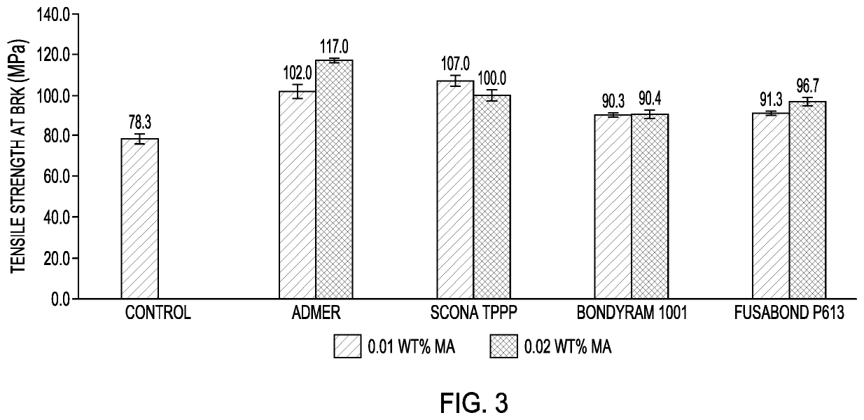

Tensile testing was carried out according to the ISO 527 method with test speed of 5 mm/min at 23° C. The tensile strength results for PP-ZOLTEK 65 carbon-fiber, PP-Toho TENAX carbon-fiber, and ZOLTEK PP2 sized carbon-fiber with various maleic anhydride grafted polypropylenes are shown in FIGS. 1, 2, and 3, respectively.

For PP-ZOLTEK 65 carbon-fiber, TOHO TENAX carbon-fiber, and ZOLTEK PP2 sized carbon-fiber compositions, incorporating PP-g-MA improves the strength properties with respect to control sample (which does not contain PP-g-MA). In SCONA, the formulation gives significant improvement in tensile strength at much lower loading at about 1/7 times compared to FUSABOND. ADMER does give similar improvement at about ⅓ times lower loading compared to FUSABOND. The favorable performance of SCONA and ADMER is believed to be due to presence of very high maleic anhydride grafting (e.g., ≥1.5 wt %) in both compounds.

As depicted in Table 1, both ZOLTEK 65 and TOHO TENAX carbon-fiber are PU sized and the sizing levels are about 2.7 wt %. TOHO TENAX carbon-fiber gives higher improvement in tensile properties compared to ZOLTEK 65 with PP-g-MA additives. The PP-g-MA additives ADMER and SCONA give improvement in tensile strength (about 30%) compared to BONDYRAM and FUSABOND with PP-TOHO TENAX carbon-fiber formulation.

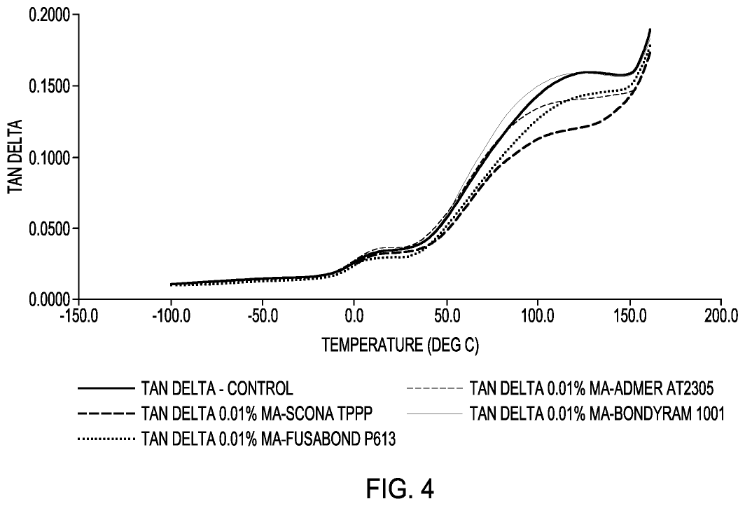

The damping ability of the each composition was measured and the DMTA-Tan delta plots for each composition are shown in FIGS. 4-9. The tan delta is basically a ratio of viscous modulus to the elastic modulus and measures the damping ability of the material. Lower tan delta values indicate that the material could release stress better, which is indicative of a good connection between fiber and resin. Materials with poor damping abilities were less likely to release stress, which is indicative of a poor connection between fiber and resin.

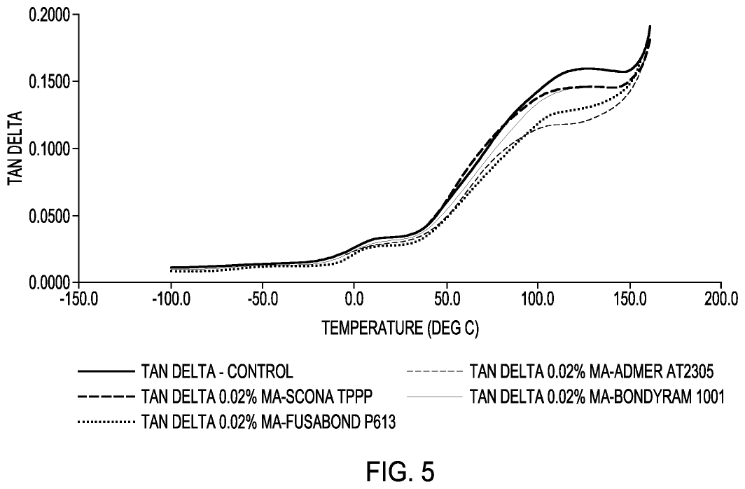

For PP-ZOLTEK 65 carbon-fiber, a sudden α-transition was observed. The lowest damping with a maleic anhydride at 0.01 wt % was observed with SCONA TPPP 9212. The lowest damping with a maleic anhydride at 0.02 wt % was observed with ADMER. These are shown in FIGS. 4 and 5, respectively.

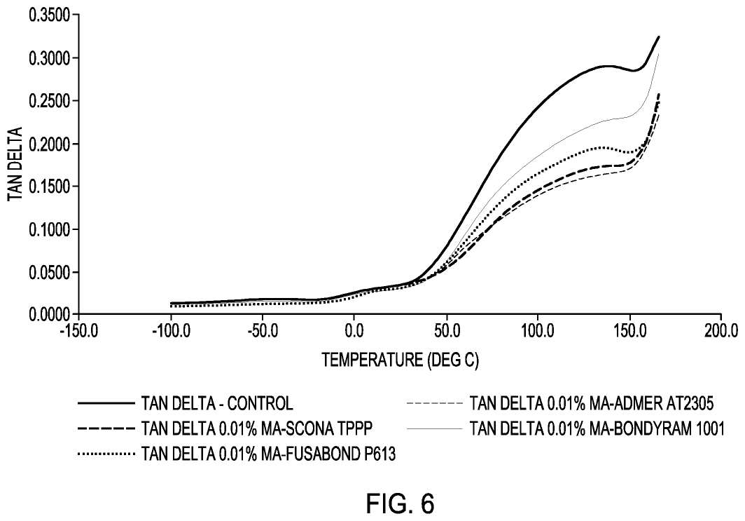

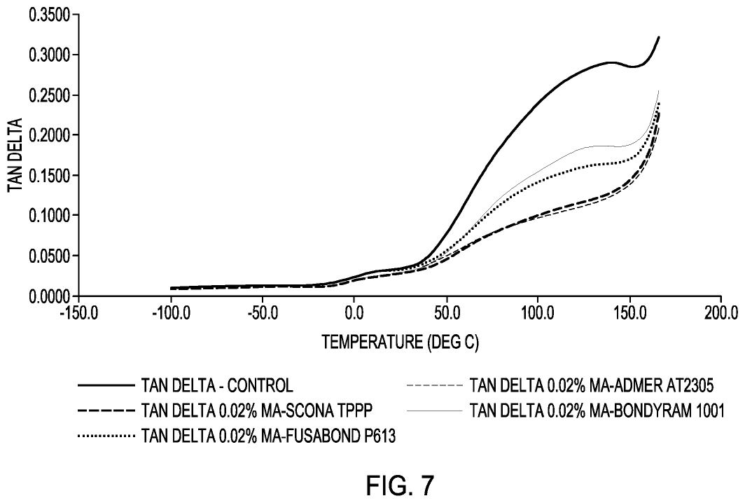

For TOHO TENAX carbon-fiber, a sudden α-transition was observed. The lowest damping with a maleic anhydride at 0.01 wt % was observed with both SCONA and ADMER. Similarly, the lowest damping with a maleic anhydride at 0.02 wt % was observed with both SCONA and ADMER. These are shown in FIGS. 6 and 7, respectively.

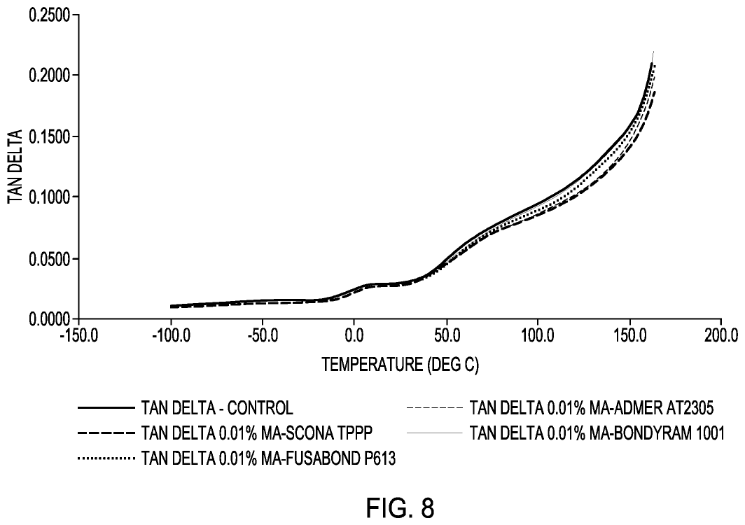

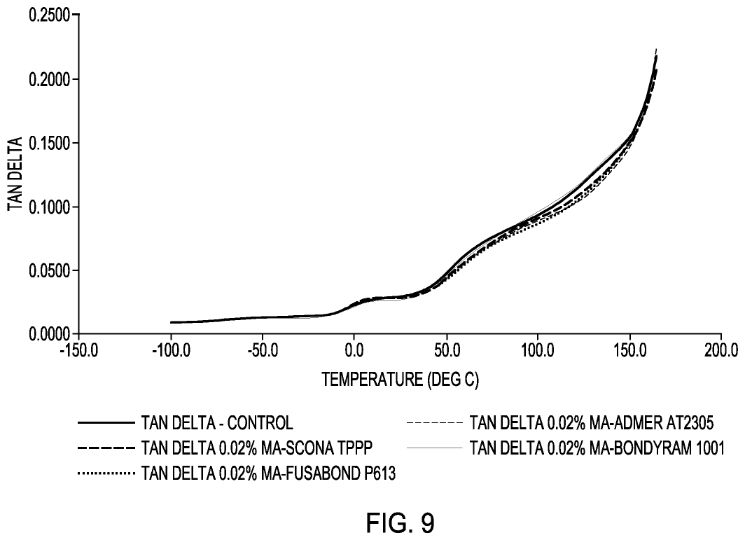

For ZOLTEK PP2, no sudden α-transition was observed. This indicated that the matrix was not as well formed with the polypropylene coated carbon-fibers as it was with the polyurethane coated carbon-fibers. The plots are shown in FIGS. 8 and 9.

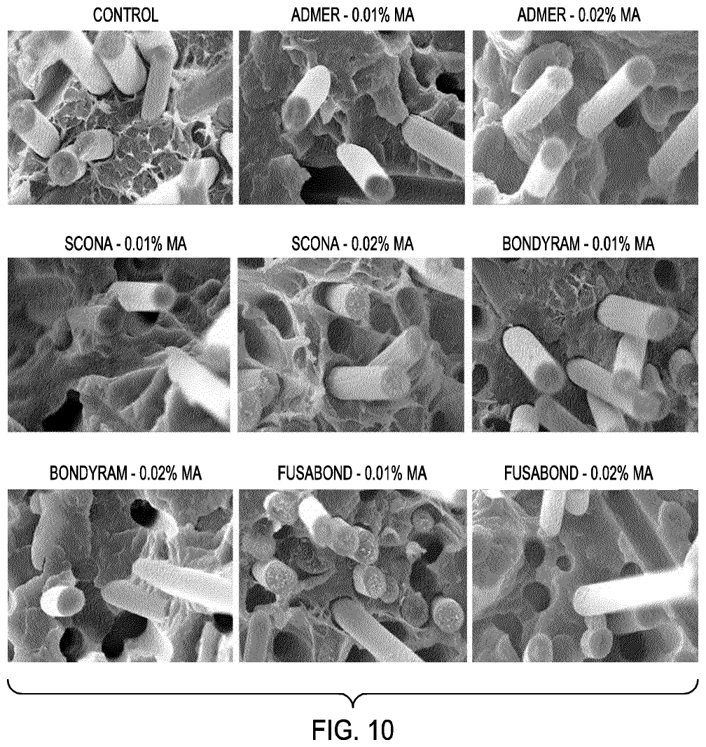

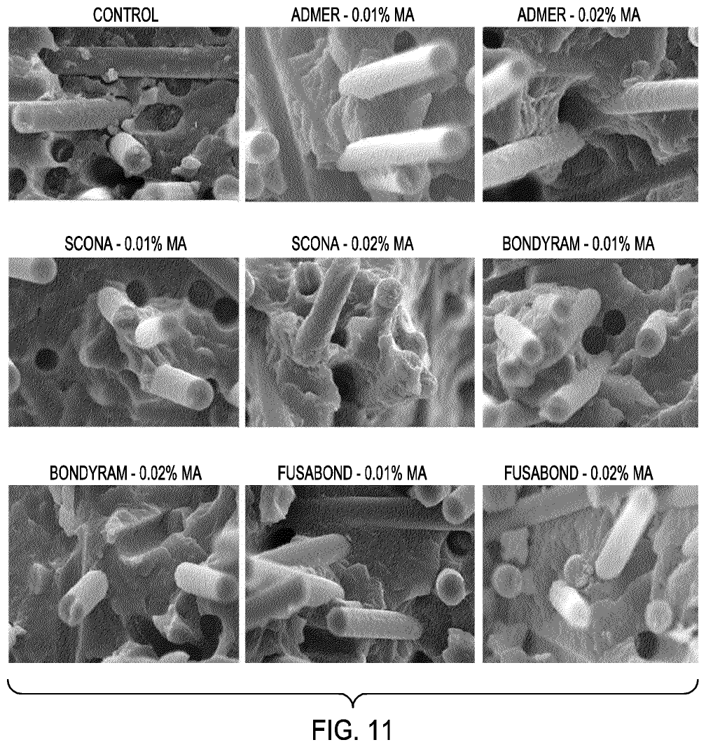

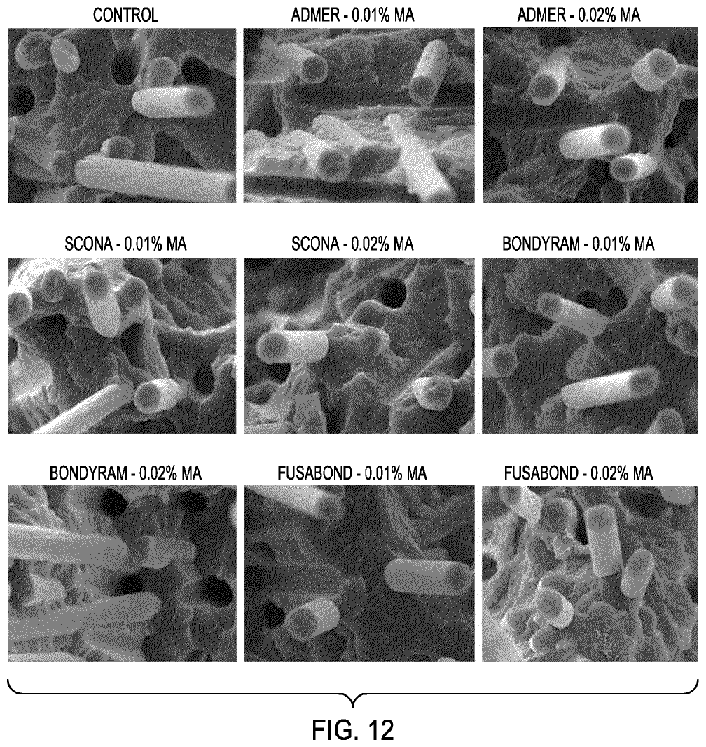

FIGS. 10, 11, and 12 show SEM micrographs of molded specimens of PP-carbon-fiber (control) and PP-carbon-fiber with PP-g-MA additives. SEM micrographs of each fiber and PP-g-MA matrix were generated to visualize the adhesion between each carbon and PP-g-MA. The micrographs are shown in FIGS. 10-12. As indicated by the micrographs, PP-TOHO TENAX carbon-fiber composition shows improved adhesion compared to PP-ZOLTEK 65 carbon-fiber composition. Both PP-TOHO TENAX carbon-fiber and ZOLTEK 65 carbon-fiber showed improved adhesion compared to ZOLTEK PP2, which is sized with polypropylene.

The tensile data and SEM show that even though ZOLTEK 65 carbon-fiber and TOHO TENAX carbon-fiber are both PU sized, with 2.7% sizing, there is a difference between the two fibers, which results in higher mechanical property for TOHO TENAX carbon-fiber. GC-MS studies were done for these PU sized carbon-fiber grades and a presence of primary amine was observed in TOHO TENAX carbon-fiber. It could be present as a chain end of PU to enhance reactivity with polymer/additives. ZOLTEK 65 does not contain a primary amine group. The presence of the primary amine group could therefore contribute to the increased tensile strength associated with TOHO TENAX.

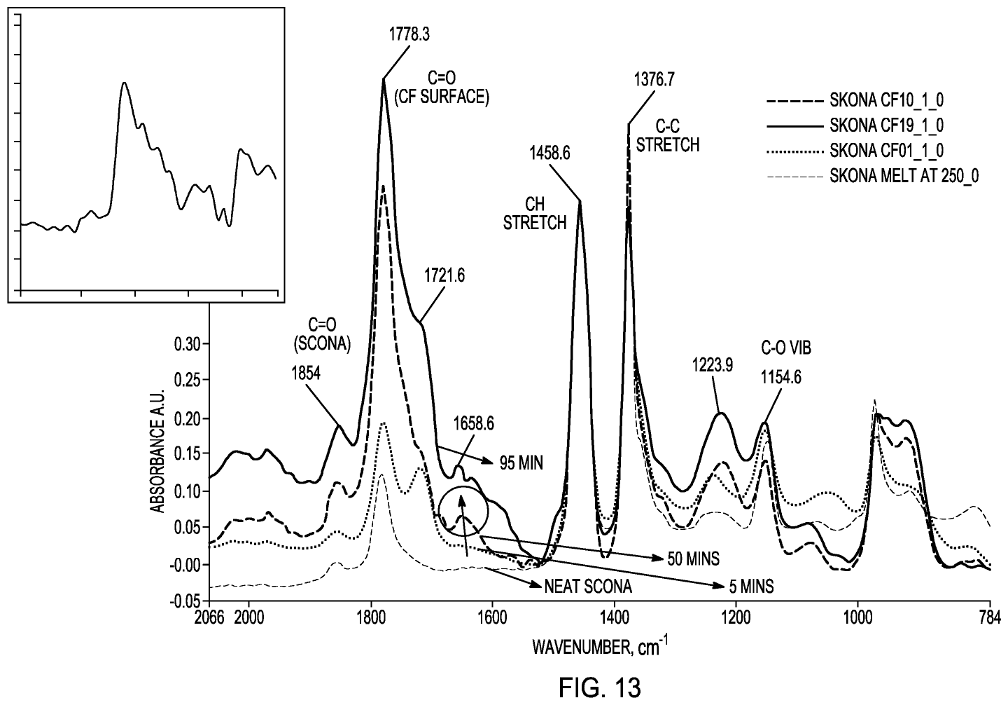

Spectroscopy was employed to understand the connections of carbon-fiber with PP-g-MA FTIR. The study was done at 250° C. to mimic the extrusion/molding conditions of the composition, findings from which are shown in FIGS. 13-16.

FIG. 13 shows the connection study of SCONA with TOHO TENAX carbon-fiber by FTIR. As shown in FIG. 13, a new peak was observed in the region of 1650-1640 cm⁻¹ which was absent in both neat SCONA and neat carbon-fiber. The intensity of this peak was found to increase with time. This could indicate an amide group formation during connection of amine group in PU of carbon-fiber with anhydride of SCONA. Also, a shift in carbon-fiber peaks observed (1) 1719 to 1778 cm⁻¹ (2) 1686 to 1721 cm⁻¹ may show the possibility of connection. No shift in the peaks attributed to C═O of SCONA (1854 cm⁻¹) was observed.

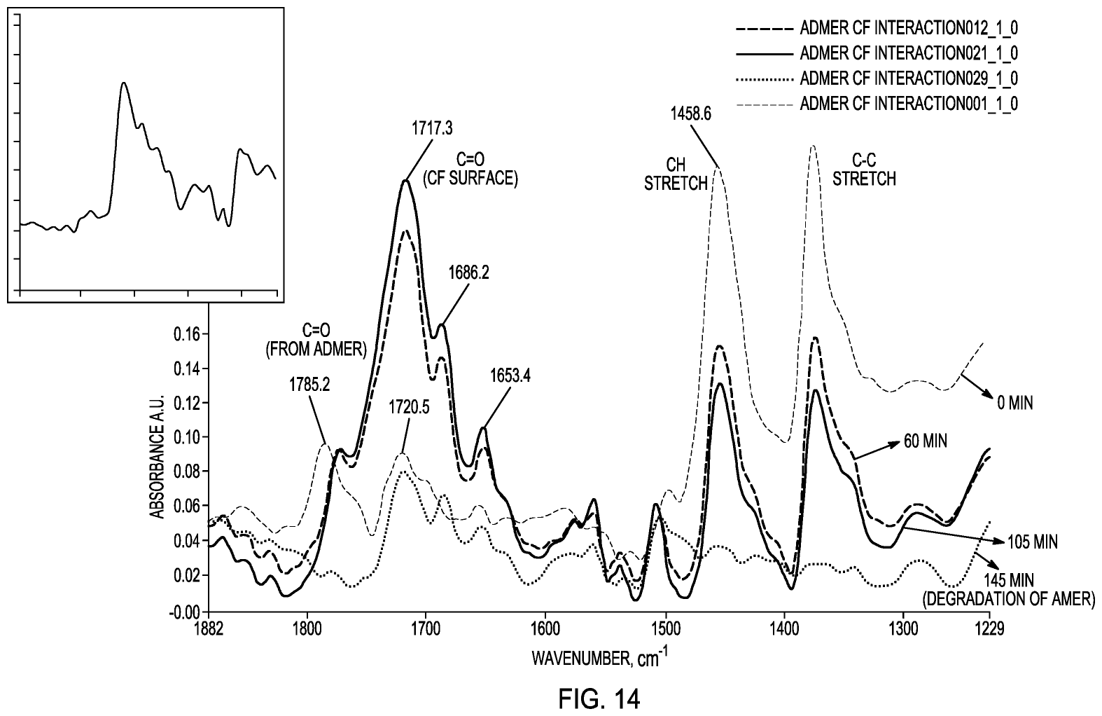

FIG. 14 shows a connection study of ADMER with TOHO TENAX carbon-fiber by FTIR studies, which show that C═O peak at 1785 cm⁻¹ for ADMER shifts to lower wavenumber (1775 cm⁻¹) as it interacts with the sized carbon-fiber (after 20 mins) No significant changes take place with time for TOHO TENAX carbon-fiber peaks.

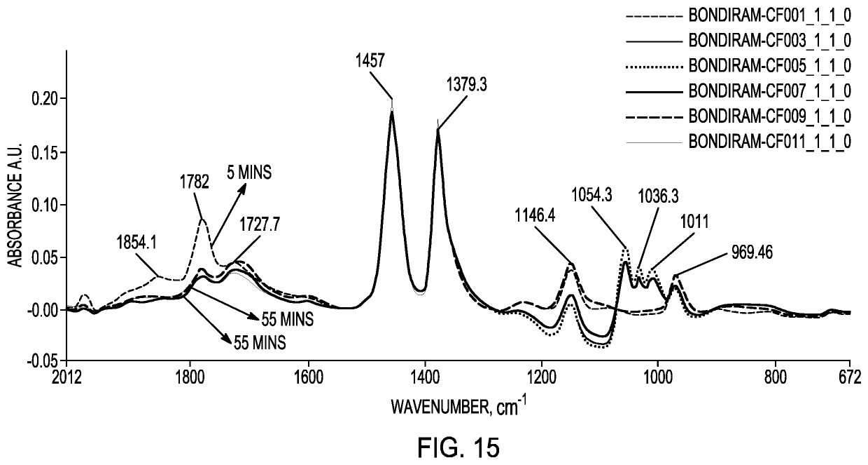

FIG. 15 shows FTIR data for connection study of BONDYRAM with TOHO TENAX carbon-fiber. FIG. 15 shows no shift in peak and no formation of a new peak for BONDYRAM. This may indicate no possible connection of BONDYRAM with TOHO TENAX carbon-fiber. This effect is reflected in the tensile property of the composition as well. A gradual decrease in the BONDYRAM peaks was also observed in FIG. 15 with time. This decrease was possibly due the degradation of the BONDYRAM.

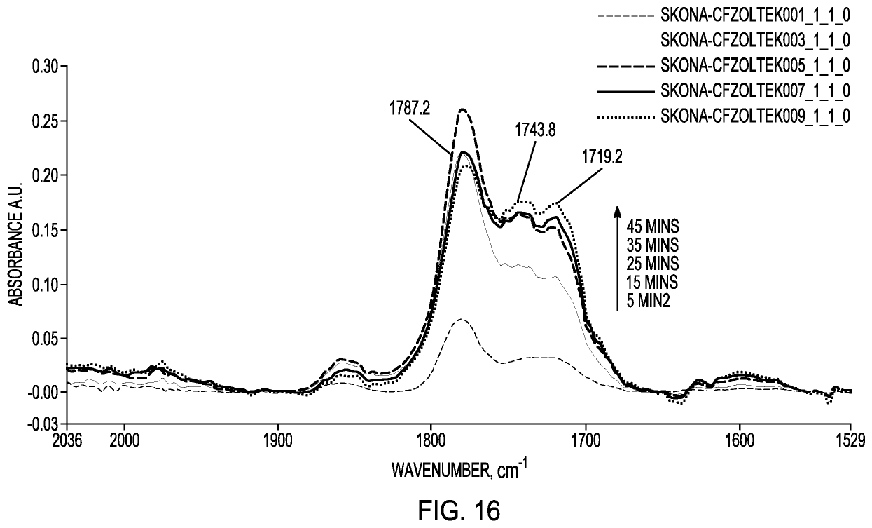

FIG. 16 shows a connection study of SCONA with ZOLTEK 65 carbon-fiber by FTIR. It can be clearly seen from FTIR that there is no appreciable shift in peak for SCONA as was observed for the SCONA and TOHO TENAX carbon-fiber study. There is an appearance of a hump around 1600 cm⁻¹ with time. This may indicate a possibility of SCONA connection with ZOLTEK 65 carbon-fiber.

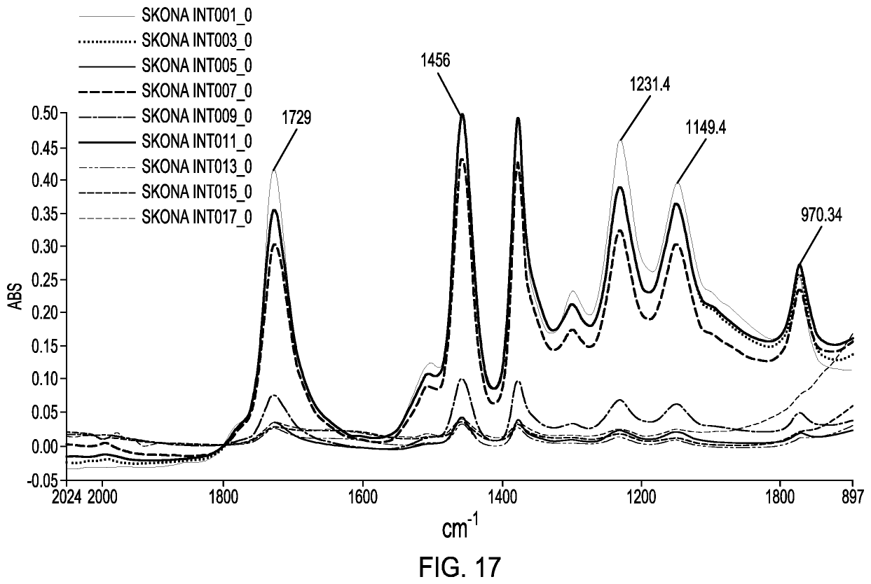

The connection study of SCONA was also carried out with Michelman's Hydrosize U2022 sizing, which is a polyurethane based sizing. FTIR data for the connection study of Hydrosize U2022 with SCONA is shown in FIG. 17. FIG. 17 shows the appearance of a new hump around 1600 cm⁻¹ with time; however, the peak was not as prominent as the SCONA-TOHO TENAX carbon-fiber connection. This may indicate possible connection of SCONA with Hydrosize U2022.

In summary, the presence of a specific functional group in PU sizing can increase the reactivity with a PP-g-MA compatibilizer and therefore can increase the overall mechanical properties (e.g., tensile strength) of the composite. It is also understood that it can be beneficial to have a higher amount of maleic anhydride grafting in PP-g-MA for more reactivity with PU sized carbon-fiber.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section.

In the methods described herein, the acts can be carried out in any order without departing from the principles of the disclosure, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

The term “about” as used herein can allow for a degree of variability in a value or range, for example, within 10%, within 5%, or within 1% of a stated value or of a stated limit of a range, and includes the exact stated value or range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more, or 100%.

The term “alkyl” as used herein refers to substituted and unsubstituted straight chain and branched alkyl groups and cycloalkyl groups having from 1 to 40 carbon atoms, 1 to about 20 carbon atoms, 1 to 12 carbons or, in some embodiments, from 1 to 8 carbon atoms. Examples of straight chain alkyl groups include those with from 1 to 8 carbon atoms such as methyl, ethyl, n-propyl, n-butyl, n-pentyl, n-hexyl, n-heptyl, and n-octyl groups. Examples of branched alkyl groups include, but are not limited to, isopropyl, iso-butyl, sec-butyl, t-butyl, neopentyl, isopentyl, and 2,2-dimethylpropyl groups. As used herein, the term “alkyl” encompasses n-alkyl, isoalkyl, and anteisoalkyl groups as well as other branched chain forms of alkyl. Representative substituted alkyl groups can be substituted one or more times with any of the groups listed herein, for example, amine, hydroxy, cyano, carboxy, nitro, thio, alkoxy, and halogen groups.

The term “cycloalkyl” as used herein refers to substituted and unsubstituted cyclic alkyl groups such as, but not limited to, cyclopropyl, cyclobutyl, cyclopentyl, cyclohexyl, cycloheptyl, and cyclooctyl groups. In some embodiments, the cycloalkyl group can have 3 to about 8-12 ring members, whereas in other embodiments the number of ring carbon atoms range from 3 to 4, 5, 6, or 7. In some embodiments, cycloalkyl groups can have 3 to 6 carbon atoms (C3-C6). Cycloalkyl groups further include polycyclic cycloalkyl groups such as, but not limited to, norbornyl, adamantyl, bornyl, camphenyl, isocamphenyl, and carenyl groups, and fused rings such as, but not limited to, decalinyl, and the like.

The term “aryl” as used herein refers to substituted and unsubstituted cyclic aromatic hydrocarbon groups that do not contain heteroatoms in the ring. Thus aryl groups include, but are not limited to, phenyl, azulenyl, heptalenyl, biphenyl, indacenyl, fluorenyl, phenanthrenyl, triphenylenyl, pyrenyl, naphthacenyl, chrysenyl, biphenylenyl, anthracenyl, and naphthyl groups. In some embodiments, aryl groups contain about 6 to about 14 carbons in the ring portions of the groups. Aryl groups can be unsubstituted or substituted, as defined herein. Representative substituted aryl groups can be mono-substituted or substituted more than once, such as, but not limited to, a phenyl group substituted at any one or more of 2-, 3-, 4-, 5-, or 6-positions of the phenyl ring, or a naphthyl group substituted at any one or more of 2- to 8-positions thereof.

The terms “halo,” “halogen,” or “halide” group, as used herein, by themselves or as part of another substituent, mean, unless otherwise stated, a fluorine, chlorine, bromine, or iodine atom.

The term “alkoxy” as used herein refers to an oxygen atom connected to an alkyl group, including a cycloalkyl group, as are defined herein. Examples of linear alkoxy groups include but are not limited to methoxy, ethoxy, propoxy, butoxy, pentyloxy, hexyloxy, and the like. Examples of branched alkoxy include but are not limited to isopropoxy, sec-butoxy, tert-butoxy, isopentyloxy, isohexyloxy, and the like. Examples of cyclic alkoxy include but are not limited to cyclopropyloxy, cyclobutyloxy, cyclopentyloxy, cyclohexyloxy, and the like. An alkoxy group can include about 1 to about 12, about 1 to about 20, or about 1 to about 40 carbon atoms bonded to the oxygen atom, and can further include double or triple bonds, and can also include heteroatoms. For example, an allyloxy group or a methoxyethoxy group is also an alkoxy group within the meaning herein, as is a methylenedioxy group in a context where two adjacent atoms of a structure are substituted therewith.

The term “substituted” as used herein refers to a group that can be or is substituted onto a molecule. Examples of substituents include, but are not limited to, a halogen (e.g., F, Cl, Br, and I); an oxygen atom in groups such as hydroxy groups, alkoxy groups, aryloxy groups, aralkyloxy groups, oxo(carbonyl) groups, carboxyl groups including carboxylic acids, carboxylates, and carboxylate esters; a sulfur atom in groups such as thiol groups, alkyl and aryl sulfide groups, sulfoxide groups, sulfone groups, sulfonyl groups, and sulfonamide groups; a nitrogen atom in groups such as amines, hydroxyamines, nitriles, nitro groups, N-oxides, hydrazides, azides, and enamines; and other heteroatoms in various other groups. Non-limiting examples of substituents include F, Cl, Br, I, OR, OC(O)N(R)₂, CN, NO, NO₂, ONO₂, azido, CF₃, OCF₃, R, O (oxo), S (thiono), C(O), S(O), methylenedioxy, ethylenedioxy, N(R)₂, SR, SOR, SO₂R, SO₂N(R)₂, SO₃R, C(O)R, C(O)C(O)R, C(O)CH₂C(O)R, C(S)R, C(O)OR, OC(O)R, C(O)N(R)₂, OC(O)N(R)₂, C(S)N(R)₂, (CH₂)₀₋₂N(R)C(O)R, (CH₂)₀₋₂N(R)N(R)₂, N(R)N(R)C(O)R, N(R)N(R)C(O)OR, N(R)N(R)CON(R)₂, N(R)SO₂R, N(R)SO₂N(R)₂, N(R)C(O)OR, N(R)C(O)R, N(R)C(S)R, N(R)C(O)N(R)₂, N(R)C(S)N(R)₂, N(COR)COR, N(OR)R, C(═NH)N(R)₂, C(O)N(OR)R, and C(═NOR)R, wherein R can be hydrogen or a carbon-based moiety; for example, R can be hydrogen, alkyl, acyl, cycloalkyl, aryl, aralkyl, heterocyclyl, heteroaryl, or heteroarylalkyl; or wherein two R groups bonded to a nitrogen atom or to adjacent nitrogen atoms can together with the nitrogen atom or atoms form a heterocyclyl. The term “acyl” as used herein refers to a group containing a carbonyl moiety wherein the group is bonded via the carbonyl carbon atom.

The term “aralkyl” as used herein refers to alkyl groups as defined herein in which a hydrogen or carbon bond of an alkyl group is replaced with a bond to an aryl group as defined herein. Representative aralkyl groups include benzyl and phenylethyl groups and fused (cycloalkylaryl)alkyl groups such as 4-ethyl-indanyl.

The term “heterocyclyl” as used herein refers to aromatic and non-aromatic ring compounds containing three or more ring members, of which one or more is a heteroatom such as, but not limited to, N, O, and S.

The term “heteroaryl” as used herein refers to aromatic ring compounds containing 5 or more ring members, of which, one or more is a heteroatom such as, but not limited to, N, O, and S; for instance, heteroaryl rings can have 5 to about 8-12 ring members. A heteroaryl group is a variety of a heterocyclyl group that possesses an aromatic electronic structure.

The term “heteroarylalkyl” as used herein refers to alkyl groups as defined herein in which a hydrogen or carbon bond of an alkyl group is replaced with a bond to a heteroaryl group as defined herein.

The term “number-average molecular weight” (Mₙ) as used herein refers to the ordinary arithmetic mean of the molecular weight of individual molecules in a sample. It is defined as the total weight of all molecules in a sample divided by the total number of molecules in the sample. Experimentally, Mₙ is determined by analyzing a sample divided into molecular weight fractions of species i having molecules of molecular weight Mᵢ through the formula Mₙ=ΣMᵢnᵢ/Σnᵢ. The Mₙ can be measured by a variety of well-known methods including gel permeation chromatography, spectroscopic end group analysis, and osmometry. If unspecified, molecular weights of polymers given herein are number-average molecular weights.

The term “weight-average molecular weight” (M_{w}), which is equal to ΣMᵢ²nᵢ/ΣMᵢnᵢ, where is the number of molecules of molecular weight Mᵢ. In various examples, the weight-average molecular weight can be determined using light scattering, small angle neutron scattering, X-ray scattering, and sedimentation velocity.

1. A composite comprising:
a carbon-fiber component comprising a sizing; and
a polypropylene component,
wherein:
the carbon-fiber component and the polypropylene component define an interface therebetween; and
the sizing comprises a polyurethane resin at least partially coating the carbon-fiber component, and at least one repeating unit of the polyurethane resin comprises at least one nucleophilic side chain interacted with the polypropylene component.

2. The composite of claim 1, wherein the carbon-fiber component is about 1 wt % to about 80 wt % of the composition.

3. The composite of claim 1 or claim 2, wherein the sizing is about 0.01 wt % to about 30 wt % of the carbon-fiber component.

4. The composite of any of claims 1 to 3, wherein at least one of the nucleophilic side chains is chosen from at least one of a hydroxyl group, a carboxyl group, and an amine group.

5. The composite of any of claims 1 to 4, wherein at least one of the nucleophilic side chains is an amine group.

6. The composite of any of claims 1 to 5, wherein the carbon-fiber component has a length ranging from about 5 microns to about 5000 meters.

7. The composite of any of claims 1 to 6, wherein the carbon-fiber component comprises one or more carbon-fibers.

8. The composite of any of claims 1 to 7, wherein the polypropylene component is about 1 wt % to about 70 wt % of the composition.

9. The composite of any of claims 1 to 8, wherein the polypropylene component comprises one or more polypropylene resins.

10. The composite of claim 9, wherein at least one of the resins of the polypropylene component comprises the structure in Formula I: 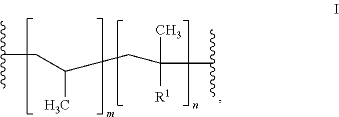
wherein R¹ is chosen from: —(C₂-C₂₀)alkoxyl, —(C₂-C₂₀)acyl, 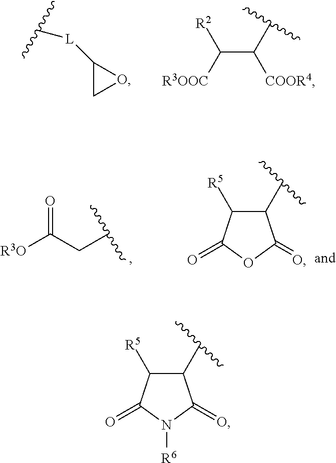
wherein L, is chosen from, a bond, —(C₂-C₂₀)alkyl, —(C₂-C₂₀)alkoxyl, —(C₂-C₂₀)alkenyl, and —(C₂-C₂₀)cycloalkyl,
wherein R², R³, R⁴, and R⁵ are independently chosen from —H, —(C₂-C₂₀)alkyl, —(C₂-C₂₀)alkoxyl, —(C₂-C₂₀)alkenyl, —(C₂-C₂₀)cycloalkyl, —(C₂-C₂₀)acyl, —(C₂-C₂₀)aryl, —C₁, and —Br,
wherein R⁶ is chosen from —H, —(C₂-C₂₀)alkyl, —(C₂-C₂₀)alkoxyl, —(C₂-C₂₀)alkenyl, —(C₂-C₂₀)cycloalkyl, —(C₂-C₂₀)acyl, and —(C₂-C₂₀)aryl,
wherein m and n represent the mole fractions of each monomer and m is from about 0.5 to about 0.95 and n is from about 0.05 to about 0.5.

11. The composite of claim 10, wherein R¹ is:

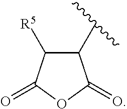

12. The composite of claim 10, wherein R¹ is:

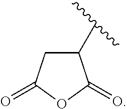 [SMILES: *C1CC(=O)OC1=O]

13. The composite of any of claims 10 to 12, wherein n is about 0.1 to about 0.4 of the polypropylene component.

14. The composite of claim 9, wherein at least one of the resins of the polypropylene component comprises at least one of a polypropylene homopolymer or copolymer.

15. The composite of any of claims 1 to 14, wherein the interface comprises a covalent bond formed between the polypropylene component and the sizing of the carbon-fiber component.

16. The composite of any of claims 10 to 13, wherein about 0.05 mol % to about 100 mol % of the R¹ groups are covalently bonded to the sizing of the carbon-fiber component.

17. A method of forming a composite material comprising
extruding a composition comprising carbon-fiber component having a sizing; and
a polypropylene component, wherein the carbon-fiber component and the polypropylene component define an interface therebetween; and the sizing comprises a polyurethane resin at least partially coating the carbon-fiber component, and at least one repeating unit of the polyurethane resin comprises at least one nucleophilic side chain interacted with the polypropylene component.

18. The method of claim 17, wherein the composition is extruded to form a pellet.

19. The method of claim 17 or claim 18, comprising:
exposing a plurality carbon-fibers having a sizing to a molten polypropylene component to form a first tape;
exposing a second plurality of carbon-fibers having a sizing to a molten polypropylene component to form a second tape;
stacking the first and second tapes; and
consolidating the first and second tapes.

20. The method of claim 19, wherein the first plurality of carbon-fibers and the second plurality of carbon-fibers are substantially parallel with respect to each other.
